(19) United States
(12) Patent Application Publication
(10) Pub. No.: US 2005/0100687 A1
(43) Pub. Date: May 12, 2005

(54) Printable film

(75) Inventors: Neill Dutton, Carlisle (GB); Richard Southward, Wigton (GB)

Correspondence Address: WENDEROTH, LIND & PONACK, L.L.P., 2033 K STREET N. W., SUITE 800, WASHINGTON, DC, 20006-1021, US

(73) Assignee: UCB, S.A., Bruxelles (BE)

(21) Appl. No.: 10/507,904

(22) PCT Filed: Mar. 19, 2003
(86) PCT No.: PCT/EP03/02868

(30) Foreign Application Priority Data
Mar. 26, 2002 (GB) 0207089.4

(51) Int. Cl. B41M 5/00

(52) U.S. Cl. 428/32.23

(57) ABSTRACT

There is described a polymer film preferably selected from polyolefin, polyester, polyamide, acrylic, polystyrene, or polyurethane, where the film is coated with an ink-jet printable ink receiving layer which when ink-jet printed has an average percent increase in droplet size on the ink receiving layer of less than about 5% between about 0.2 and about 2.0 sec after printing. Also described are printable films optionally with the preceding property which have an inkjet printable top coat layer comprising A), B) or C) where: A) is at least one halogenated terpolymer obtained and/or obtainable from the following polymer precursors: (a) halogenated vinyl, optionally vinyl chloride; (b) vinyl ester, optionally vinyl acetate; (c) olefin, optionally ethylene; B) is at least one copolymer obtained and/or obtainable from two of the following polymer precursors (i) halogenated vinyl, optionally vinyl chloride; (ii) vinyl ester, optionally vinyl acetate; (iii) olefin, optionally ethylene; and C) is at least one a vinylidene halide copolymer obtained and/or obtained from (x) a PVdX polymer precursor; and (y) a functionalised acrylic polymer precursor which comprises an olefinic monomer substituted by one or more non-halogenated electronegative groups.

The present invention relates to improved substrates for use in digital printing methods such as plastic films having thereon a receptive coating printable with ink-jettable inks, the film being useful for example in label and graphic arts applications

Digital printing is increasingly used over conventional printing methods for many applications such as for the labels and in the graphic arts. Digital printing methods (such as ink-jet printing) have the advantage that no printing plates need be prepared in advance and thus the substrate can be immediately printed with the data sent to the printer. Digital printing is especially suitable for low volume print runs or for variable information printing where the information printed to each article can be different. This is useful for example where products need to be individually traced, or to customise products for example for different seasons, for competitions; In different languages or for test products. Costs can be reduced as less pre-printed material needs to be stored. Ink-jet printing (both piezo and thermal IJ) is the form of digital printing which is most widely used for example in the label and graphic arts fields.

Paper has conventionally been used as the substrate of choice for digital printing. But paper is unsuitable as a substrate for certain applications. For example in outdoor graphic art applications durability of a paper substrate is an issue. Paper is also prone to tearing when for example as the label facestock in high speed labelling machines. Paper is less suitable in environments subject to high ambient temperatures or high humidity. So polymeric film substrates are often preferred over paper. However uncoated plastic films are generally difficult to print with digital printing methods because of the low absorption of the ink on the film (which leads to droplet spread and low resolution) and low ink adhesion which leads to smearing and rub off. Only certain PVC films have been found to be printable by digital methods without further surface coating.

Yet for many applications of printable polymer films (such as labels or graphic art displays) it is important to have a wide choice in the film that may be selected so that the substrate performance and appearance characteristics can be chosen to match to the particular application. Each polymer film exhibits different performance and appearance properties and common label films such as: acetate; polyethylene (PE); polystyrene (PS); polypropylene (PP); vinyl (PVC) and polyester (PET), are each more appropriately selected to particular end uses.

So whilst it is desirable to use digital printing methods in many applications it is also desirable to retain the flexibility to chose a wide variety of different film types so that the substrate performance and appearance characteristics can be matched to the particular end use.

Due to the constraints imposed on the ink due to the nature of the ink jetting process, whether in a thermal or piezo ink jet printer, it is preferable that the ink receiving surface of the substrate is modified rather than the ink itself to optimise some or all of the desired properties in the final printed image.

Some of the criteria that an ideal ink-jet receptive substrate will possess include some or all of the following, depending on the particular application (e.g. for a “no-label” look transparency is important rather than whiteness or opacity). A suitable ink-jet printable substrate will have good optical properties such as brightness, whiteness, gloss, opacity and/or colour gamut to give high-quality printed images. The substrate should be compatible with components in the ink to ensure that the final ink image has sufficient fastness and low tendency to fade for example when exposed to UV light. The absorbency of the film surface is important. Ink jet printing places special demands on the substrate which is printed with a large amount of liquid, and yet is expected to dry quickly without changing size or shape. Although paper fibres absorb liquid well, but they swell and deform, resulting in surface imperfections and such moisture-induced undulations have a detrimental effect on image quality. Paper is also unsuitable for many applications as described herein. A suitable substrate will be durable that is will maintain its structure for the time of the print and thus is determined by its dimensional stability, tear resistance, thermal stability, and water and light resistance. The ink jet printable coating and film are both relevant components when determining the durability of the media. Thus to produce a good image by an ink jet printer the ink receiving surface should be dimensionally and thermally stable, i.e. not tear, stretch or deform, should be smooth and waterproof, maintain its shape and be resistant to many chemicals and should not swell or shrink with moisture or humidity.

Uncoated PVC film has been used as a film substrate for ink jet printing but has other disadvantages as a substrate for applications such as graphic arts or labels. However many non-PVC films are not very receptive to common ink jet printable inks such as solvent based inks. It would be desirable to provide a coating which allows other film substrates such as polyolefinic films (e.g. PE or PP) to be used and which provides some or all of those properties desired in an ink jet printable surface.

Some prior art digitally printable polymer films will now be described

WO 98/04418 (3M) discloses an image receptor medium including an image reception layer comprises an acid- or acid/acrylate-modified ethylene vinyl acetate (EVA) resin. The image receptor medium may further include an optional primer layer, an optional adhesive layer, and an optional inkjet layer.

WO 99/28791 (3M) describes multiple-layer imaging media for electrostatic printing comprising: a backing layer of polypropylene, an intermediate layer which may, for example, comprise an ethylene-alpha-olefin polymer, and a receptor layer. The imaging media are particularly useful in electrophotographic printing processes with liquid toners comprising thermoplastic toner particles in a liquid carrier that is not a solvent for the particles at a first temperature and that is a solvent for the particles at a second temperature or with dry toner. The inks used in electrophotography are very different from those used in an ink jet printing process.

WO 00/20521 (3M) describes novel piezo ink-jet inks and substrates which can be printing these specific inks.

WO 00/52532 (3M) (=U.S. Pat. No. 6,316,120) discloses a non-halogenated image receptor medium comprising a polyolefin, polyester, polyamide, acrylic, polystyrene, or polyurethane film coated with an imaging receiving layer of a ethylene vinyl acetate terpolymer on the film outer surface. This document specifically teaches away from using any chlorinated species in either the film or the film coat layer.

FR 2312371 discloses plastic surfaces with ink receptive layers comprising either a) acrylate or methacrylate copolymers containing carboxyl groups or b) copolymers of vinyl chloride or vinyl acetate.

FR 2352667 describes a printable layer on a plastics material for receiving an ink inscription. The layer can contain talc or colloidal silica with a binder which can be polyvinyl acetate or a copolymer of a vinyl chloride or vinyl acetate

GB 2 050 866A (Fuji Photo) describes a recording sheet for inkjet printing with aqueous inks which is formed by applying a layer of a water soluble polymer to a support. The coating formed has a water absorption of not more than 30 gm/m². A long list of suitable polymers includes vinyl acetate maleic anhydride copolymer.

EP 0228835-A (3M) describes a receptor film for thermal mass transfer printing which is different from ink jet printing.

EP 0315063-A (Hitachi Maxell) describes an article comprising a substrate and an indicia-receiving layer on the substrate which comprises a pigment and at least one binder resin selected from the group consisting of vinyl chloride-vinyl acetate copolymers and polyurethane.

EP 0507409-A (Arkwright) describes a fast drying printing film composite for use in offset lithography and similar printing applications comprising a transparent, translucent or opaque film substrate having an ink receptive essentially transparent polymeric layer on at least one side of the substrate, said ink receptive layer containing one or more polymers or copolymers, at least one of said polymers or copolymers being soluble or swellable in an aliphatic hydrocarbon solvent, said ink receptive layer having a solvent absorptivity of Isopar G of from 14% to 45% by weight with respect to the weight of the ink receptive layer, a Sheffield surface roughness value of less than 140 cc of air/minute and an offset dry time of less than about two hours.

EP 0524635-A (Mitsubishi Paper Mills) describes an ink jet recording sheet which can have an ink receiving layer which includes an ethylene-vinyl acetate copolymer resin but other integers are required in the coating.

EP 0778156-A (Oce) describes a multi-purpose imageable sheet useful for multiple applications including manual drafting, ink jet recording and electrophotographic printing and copying. The sheet comprises a base support and a surface coating on at least one side thereof, with the surface coating being formed from an aqueous-based coating formulation that comprises an aqueous dispersion of (i) a cross-linkable polymer and a cross-linking agent therefor, and (ii) a pigment. The surface coating is a pencil, ink and toner receptive cross-linked surface layer that embodies properties that make its surface suitable as a receptor for a variety of imaging means.

EP 1122083-A (Mitsubishi Paper Mills) describes an ink jet recording material for non-aqueous ink, which comprises an ink-absorbing layer containing at least a pigment on a support, the ink-absorbing layer being coated or impregnated with a polymer soluble or swellable in a petroleum system high boiling point solvent, wherein at least 30% by weight of the pigment is calcium carbonate.

U.S. Pat. No. 3,450,557 (Dratz et al) describes ink receptive surfaces are formed on a polyolefin surface by coating with a polyvinyl alcohol coating composition which has at least about 88% hydrolysed acetate radicals and about 1 to 10% of polyethyleneimine based on PVA solids. Potassium pyroantiminonate can also be present. An alcohol based ink is used in one example.

U.S. Pat. No. 3,489,597 (Parker) discloses plastic surfaces are made ink receptive by coating with a composition containing a copolymer of vinyl acetate and vinylpyrrolidone. There is no specific reference to polyolefin films.

U.S. Pat. No. 4,085,245 (Xerox) describes a transparency for coloured xerographic copies includes a layer which includes as components a mixture of an acrylic polymer and a copolymer of vinyl acetate and vinyl chloride.

U.S. Pat. No. 4,904,519 (3M) describes a polymeric composition suitable for preparing an ink receptive coating for a recording sheet and the recording sheet formed therefrom. The composition comprises a hydrolysed copolymer formed from vinyl amide monomer units and vinyl ester monomer units. The recording sheets of the invention can be imaged by means of pen plotters or ink jet printers that use either water-based inks or solvent based inks.

U.S. Pat. No. 6,113,679 (3M) describes a method of printing substrates by piezo inkjet inks wherein the receiving substrate is a single and multi-layer constructions of acrylic-containing films, poly(vinyl chloride)-containing films, urethane-containing films, melamine-containing films, polyvinylbutyral-containing films, a multi-layered film having an image reception layer comprising an acid- or acid/acrylate modified ethylene vinyl acetate resin, a multi-layered film having an image reception layer comprising an image reception layer comprising a polymer comprising at least two monoethylenically unsaturated monomeric units, wherein one monomeric unit comprises a substituted alkene where each branch comprises from 0 to about 8 carbon atoms and wherein one other monomeric unit comprises a (meth)acrylic acid ester of a nontertiary alkyl alcohol in which the alkyl group contains from 1 to about 12 carbon atoms and can include heteroatoms in the alkyl chain and in which the alcohol can be linear, branched, or cyclic in nature.

All of these films have some disadvantages when being printed with ink-jettable inks.

Therefore it is any object of the present invention to overcome some of the problems described herein to provide a film substrate which is printable by a digital printing method, preferably ink-jet printing, for example by providing a coating suitable for use with a wide variety of common film types to improve their reception to ink-jettable inks.

Therefore broadly in accordance with the present invention there is provided a polymer film optionally selected from polyolefin, polyester, polyamide, acrylic, polystyrene, or polyurethane, where the film is coated with an ink-jet printable ink receiving layer which when ink-jet printed has an average percent increase in droplet size on the ink receiving layer of less than about 5% between about 0.1 and about 5 sec after printing.

Further embodiments and optional features of the present invention are provided in the claims herein.

Typical solvent based inks (i.e. non-aqueous system ) can be inkjet printed onto uncoated PVC films. Typical solvent ink jet inks use vinyl resins and solvent systems such as glycols, glycol ethers and/or lactates that in-turn dissolve the PVC substrate to give good adhesive “key” to the dried print. Print quality is determined by ink-drop spread which is governed by relative substrate-ink surface energies (contact angle) and substrate-solvent interactions (dissolution/absorption) which will also be coat weight dependant.

The applicant has discovered a polymer system which can coat non PVC substrates such as polyolefinic films (e.g. OPP) to give PVC-like surface characteristics such as similar surface energy and solubility in the solvents used with typical ink jet inks.

Various coated OPP samples were tested based on aqueous dispersion/emulsions of: PVdC; Ethylene-Vinyl Chloride (E/VC) copolymer, Ethylene-Vinyl Acetate (E/VA) copolymer, and Ethylene-VC-VA terpolymers as described herein.

Vinylidene halide polymers (also denoted herein by PVdX where X is halo) are homo or co polymers which comprise a repeat unit of the following formula 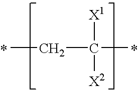
where X¹ and X² are independently halo. For a polymer repeat unit the asterisks in the formula denote the attachment to the polymer chain and/or repeat unit of terminal groups and/or other repeat units (i.e. when the polymer is a copolymer). For a polymer precursor (.e.g. monomer) of the same formula the asterisks denote reactive groups such as H, which allow the precursor to be polymerised. When X¹ and X² are both Cl the above polymer is poly vinylidene chloride (known herein as PVdC). When X¹ and X² are both F the above polymer is poly vinylidene fluoride (PVdF). Coatings of the present invention optionally comprises PVdX type copolymers where the other polymer precursor is functionalised acrylic.

Unless the context clearly indicates otherwise, as used herein plural forms of the terms herein are to be construed as including the singular form and vice versa.

The term “comprising” as used herein will be understood to mean that the list following is non-exhaustive and may or may not include any other additional suitable items, for example one or more further feature(s), component(s), ingredient(s) and/or substituent(s) as appropriate.

The terms ‘effective’, ‘acceptable’ ‘active’ and/or ‘suitable’ (for example with reference to any process, use, method, application, preparation, product, material, formulation, compound, monomer, oligomer, polymer precursor, and/or polymers of the present invention and/or described herein as appropriate) will be understood to refer to those features of the invention which if used in the correct manner provide the required properties to that which they are added and/or incorporated to be of utility as described herein. Such utility may be direct for example where a material has the required properties for the aforementioned uses and/or indirect for example where a material has use as a synthetic intermediate and/or diagnostic tool in preparing other materials of direct utility. As used herein these terms also denote that a functional group is compatible with producing effective, acceptable, active and/or suitable end products. Preferred utility of the present invention comprises a polymeric film substrate which is capable of being ink jet printed to produce a good image therein, more preferable in the field of label and/or graphic art applications.

The terms ‘optional substituent’ and/or ‘optionally substituted’ as used herein (unless followed by a list of other substituents) signifies the one or more of following groups (or substitution by these groups): carboxy, sulpho, formyl, hydroxy, amino, imino, nitrilo, mercapto, cyano, nitro, methyl, methoxy and/or combinations thereof. These optional groups include all chemically possible combinations in the same moiety of a plurality (preferably two) of the aforementioned groups (e.g. amino and sulphonyl if directly attached to each other represent a sulphamoyl group). Preferred optional substituents comprise: carboxy, sulpho, hydroxy, amino, mercapto, cyano, methyl, halo, trihalomethyl and/or methoxy.

The synonymous terms ‘organic substituent’ and “organic group” as used herein (also abbreviated herein to “organo”) denote any univalent or multivalent moiety (optionally attached to one or more other moieties) which comprises one or more carbon atoms and optionally one or more other heteroatoms. Organic groups may comprise organoheteryl groups (also known as organoelement groups) which comprise univalent groups containing carbon, which are thus organic, but which have their free valence at an atom other than carbon (for example organothio groups). Organic groups may alternatively or additionally comprise organyl groups which comprise any organic substituent group, regardless of functional type, having one free valence at a carbon atom. Organic groups may also comprise heterocyclyl groups which comprise univalent groups formed by removing a hydrogen atom from any ring atom of a heterocyclic compound: (a cyclic compound having as ring members atoms of at least two different elements, in this case one being carbon). Preferably the non carbon atoms in an organic group may be selected from: hydrogen, halo, phosphorus, nitrogen, oxygen, silicon and/or sulphur, more preferably from hydrogen, nitrogen, oxygen, phosphorus and/or sulphur.

Most preferred organic groups comprise one or more of the following carbon containing moieties: alkyl, alkoxy, alkanoyl, carboxy, carbonyl, formyl and/or combinations thereof; optionally in combination with one or more of the following heteroatom containing moieties: oxy, thio, sulphinyl, sulphonyl, amino, imino, nitrilo and/or combinations thereof. Organic groups include all chemically possible combinations in the same moiety of a plurality (preferably two) of the aforementioned carbon containing and/or heteroatom moieties (e.g. alkoxy and carbonyl if directly attached to each other represent an alkoxycarbonyl group).

The term ‘hydrocarbo group’ as used herein is a sub-set of an organic group and denotes any univalent or multivalent moiety (optionally attached to one or more other moieties) which consists of one or more hydrogen atoms and one or more carbon atoms and may comprise one or more saturated, unsaturated and/or aromatic moieties. Hydrocarbo groups may comprise one or more of the following groups. Hydrocarbyl groups comprise univalent groups formed by removing a hydrogen atom from a hydrocarbon (for example alkyl). Hydrocarbylene groups comprise divalent groups formed by removing two hydrogen atoms from a hydrocarbon, the free valencies of which are not engaged in a double bond (for example alkylene). Hydrocarbylidene groups comprise divalent groups (which may be represented by “R₂C═”) formed by removing two hydrogen atoms from the same carbon atom of a hydrocarbon, the free valencies of which are engaged in a double bond (for example alkylidene). Hydrocarbylidyne groups comprise trivalent groups (which may be represented by “RC≡”), formed by removing three hydrogen atoms from the same carbon atom of a hydrocarbon the free valencies of which are engaged in a triple bond (for example alkylidyne). Hydrocarbo groups may also comprise saturated carbon to carbon single bonds (e.g. in alkyl groups); unsaturated double and/or triple carbon to carbon bonds (e.g. in respectively alkenyl and alkynyl groups); aromatic groups (e.g. in aryl groups) and/or combinations thereof within the same moiety and where indicated may be substituted with other functional groups

The term ‘alkyl’ or its equivalent (e.g. ‘alk’) as used herein may be readily replaced, where appropriate and unless the context clearly indicates otherwise, by terms encompassing any other hydrocarbo group such as those described herein (e.g. comprising double bonds, triple bonds, aromatic moieties (such as respectively alkenyl, alkynyl and/or aryl) and/or combinations thereof (e.g. aralkyl) as well as any multivalent hydrocarbo species linking two or more moieties (such as bivalent hydrocarbylene radicals e.g. alkylene).

Any radical group or moiety mentioned herein (e.g. as a substituent) may be a multivalent or a monovalent radical unless otherwise stated or the context clearly indicates otherwise (e.g. a bivalent hydrocarbylene moiety linking two other moieties). However where indicated herein such monovalent or multivalent groups may still also comprise optional substituents. A group which comprises a chain of three or more atoms signifies a group in which the chain wholly or in part may be linear, branched and/or form a ring (including spiro and/or fused rings). The total number of certain atoms is specified for certain substituents for example C_{1-N}organo, signifies a organo moiety comprising from 1 to N carbon atoms. In any of the formulae herein if one or more substituents are not indicated as attached to any particular atom in a moiety (e.g. on a particular position along a chain and/or ring) the substituent may replace any H and/or may be located at any available position on the moiety which is chemically suitable and/or effective.

Preferably any of the organo groups listed herein comprise from 1 to 36 carbon atoms, more preferably from 1 to 18. It is particularly preferred that the number of carbon atoms in an organo group is from 1 to 12, especially from 1 to 10 inclusive, for example from 1 to 4 carbon atoms.

As used herein chemical terms (other than IUAPC names for specifically identified compounds) which comprise features which are given in parentheses—such as (alkyl)acrylate, (meth)acrylate and/or (co)polymer—denote that that part in parentheses is optional as the context dictates, so for example the term (meth)acrylate denotes both methacrylate and acrylate.

The substituents on the repeating unit of a polymer and/or oligomer may be selected to improve the compatibility of the materials with the polymers and/or resins in which they may be formulated and/or incorporated for the uses described herein. Thus the size and length of the substituents may be selected to optimise the physical entanglement or interlocation with the resin or they may or may not comprise other reactive entities capable of chemically reacting and/or cross-linking with such other resins as appropriate.

Certain moieties, species, groups, repeat units, compounds, oligomers, polymers, materials, mixtures, compositions and/or formulations which comprise and/or are used in some or all of the invention as described herein may exist as one or more different forms such as any of those in the following non exhaustive list: stereoisomers (such as enantiomers (e.g. E and/or Z forms), diastereoisomers and/or geometric isomers); tautomers (e.g. keto and/or enol forms), conformers, salts, zwitterions, complexes (such as chelates, clathrates, crown compounds, cyptands/cryptades, inclusion compounds, intercalation compounds, interstitial compounds, ligand complexes, organometallic complexes, non-stoichiometric complexes, π-adducts, solvates and/or hydrates); isotopically substituted forms, polymeric configurations [such as homo or copolymers, random, graft and/or block polymers, linear and/or branched polymers (e.g. star and/or side branched), cross-linked and/or networked polymers, polymers obtainable from di and/or tri-valent repeat units, dendrimers, polymers of different tacticity (e.g. isotactic, syndiotactic or atactic polymers)]; polymorphs (such as interstitial forms, crystalline forms and/or amorphous forms), different phases, solid solutions; and/or combinations thereof and/or mixtures thereof where possible. The present invention comprises and/or uses all such forms which are effective as defined herein.

Particulate materials may be added to the coat to further improve solvent absorption. For example up to 50% by dry weight of the coating of any of the following: inorganic pigments such as silica (colloidal, fumed and/or precipitated); calcium carbonate, titanium dioxide, talc and/or aluminium silicates, inorganic clays such as smectite, bentonite etc; micro-crystalline cellulose and/or any suitable mixtures thereof: Preferably the major axis of the particles has a mean size from about 10 nanometres to about 10 microns. More preferably the partcles have an aspect ratio of about 1 (i.e. are not needle shaped but substantially cubiod or spherical in shape). Optionally the particles are incorporated in the coating composition in an amount of from about 10% to about 85%, preferably from about 15% to about 50%, by dry weight of the total coating.

Optionally other conventional additives may be incorporated into the composition. Suitable additives are emulsifiers, anti-foaming agents, coalescing agents, dispersing agents, wefting agents, anti-settling agents, thickeners, flatting agents, and/or stabilisers.

The coated films of the present invention have surface characteristics (surface tensions and solubility parameters) that give good print resolution and adhesion.

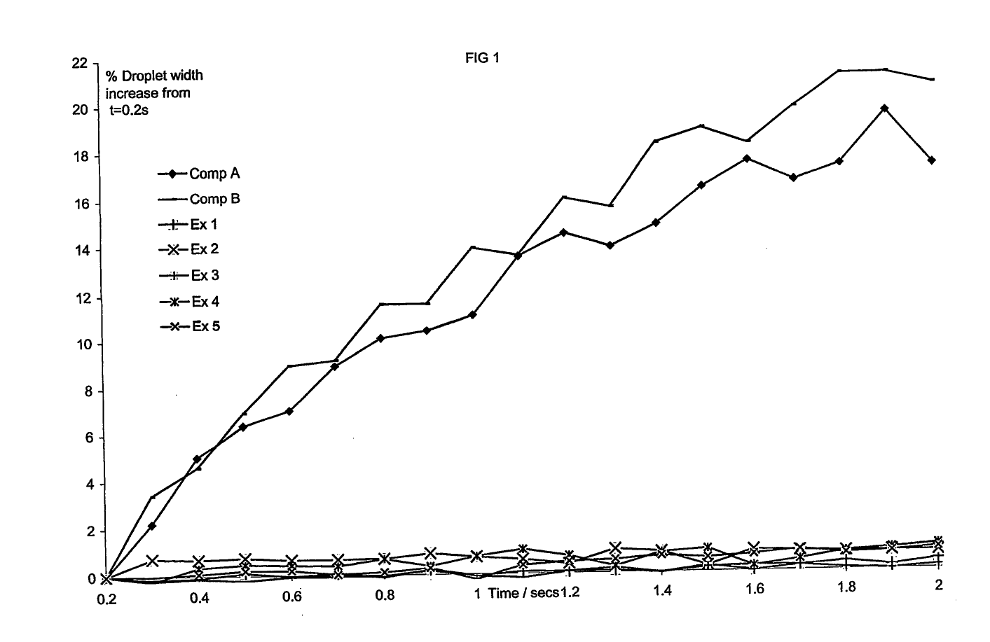

The present invention is illustrated by the FIGS. 1 to 3 herein which are plots showing the time taken on average for an ink jet droplet to spread onto a surface of a film as measured by the percentage increase of the drop width over the first 2 seconds after printing. Prior art films (Comp A to E—see below) were compared with coated BOPP films of the present invention (Examples 1 to 11—see below): To allow for variation in the droplet size at time zero due to “bounce” of the jetted droplet from the substrate the measurements were related to changes in the droplet size compared to that 0.2 seconds after printing.

FIG. 1 compares the terpolymer coated films Examples 1 to 5 with Comp A to C.

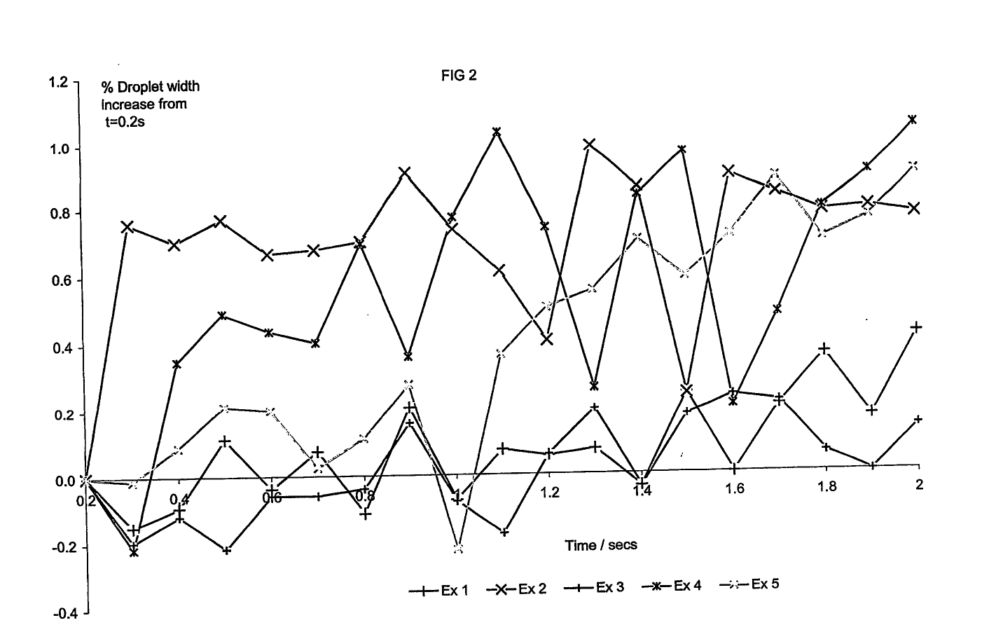

(FIG. 2 shows the same data for Examples 1 to 5 without the comparative data to expand the ordinate).

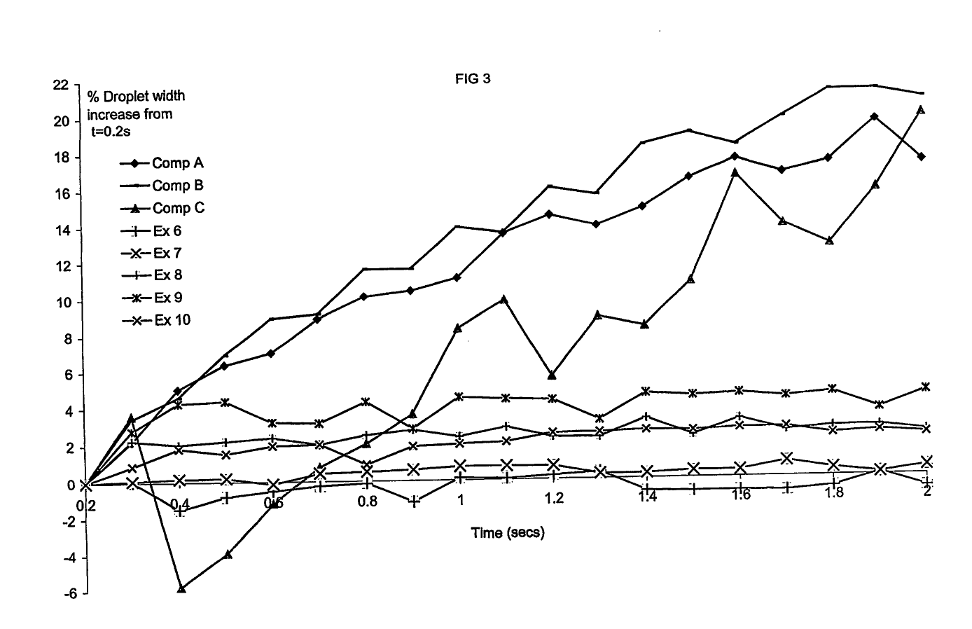

FIG. 3 compares the copolymer coated films Examples 6 to 10 with Comp A to C.

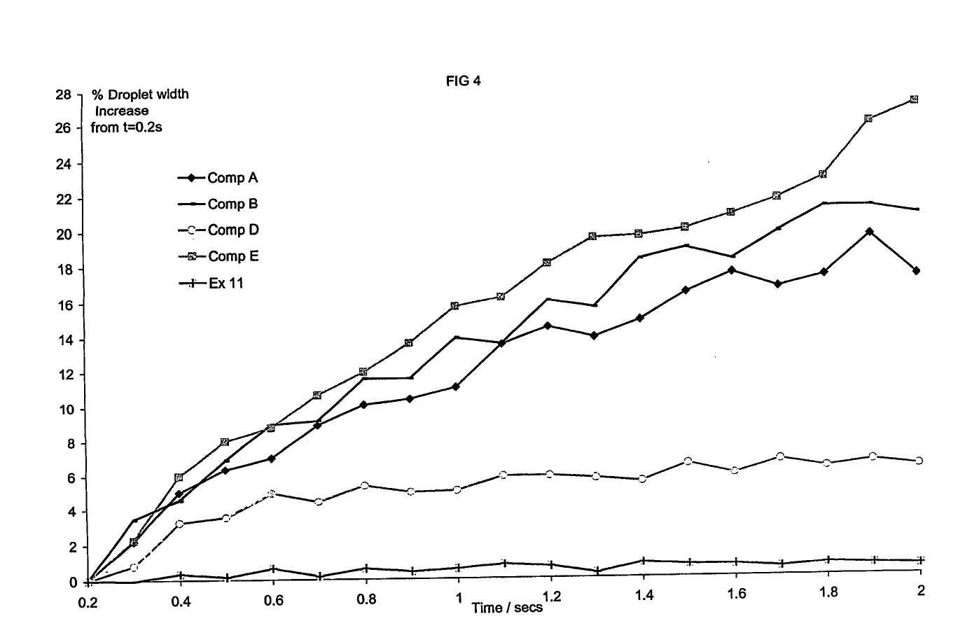

FIG. 4 compares a functionalised PVdC polymer coated films Example 11 with Comp A to E.

The present invention will now be illustrated by reference to the following non-limiting examples.

A series of experiments were performed which measured surface energies of a PVC film versus a range of the above coatings. The Wu and Owens-Wendt models for surface energy calculations were both used (to give polar and dispersive components).

Hildbrand solubility parameters were used to predict polymer/solvent interactions and these were further broken down into Hansen parameters where dispersive, polar and H-bonding components are considered
Hildebrand˜[(δ_{d})²+(δₚ)²+(δₕ)²]^{0.5})
where δ_{d}, δₚ and δₕ are the respectively the Hansen dispersive, polar and hydrogen bonding parameters

Typical solvents used in vinyl ink formulations for ink jet printing are: cyclohexanone, propylene glycol monomethyl ether acetate, ethylene glycol butyl ether acetate, diethylene glycol ethyl ether acetate, isophorone; dipropylene glycol monomethyl acetate, lactates, MEK, and/or acetates and/or any suitable mixtures thereof.

To find the most similar surface to the PVC, various exemplified coating formulations were applied using a Dixon coater in a conventional manner to a primed conventional BOPP base film of 90 microns thickness. The coated film surface was tested in a conventional manner using a contact angle machine to find the average contact angle of a conventional ink-jet ink on the coated surface, the average base width (i.e. the droplet spread on the surface) and the average volume for the ink droplet. The surface energies of the unprinted films were also tested.

The ink used throughout these tests was a conventional solvent based black ink formulated for an piezo ink jet printing (Sunjet Crystal SOV 7575), although it will be appreciated that any suitable ink-jet ink could have been used in these tests. Various prior art films (Comp A to Comp E as described herein) were used as standards to compare the various coatings. Three individual tests were done on each sample and then averaged. The data for the % droplet width increase versus time from 0.2 seconds to 2.0 seconds after printing is presented in more detail herein (see FIGS. 1 to 3).

### EXAMPLES 1 TO 11

The coating formulations used were as follows. All the copolymer and terpolymers used in the Example herein were available commercially from Air Product under the trade name Airflex plus the given trade designations. The PVdC polymer was available commercially from Solvin under the given trade designation. On application before drying all these formulations comprised 20% solids and 80% water except CE 35 which comprised 25% solids and 75% water and A115 which comprised 45% solids and 55% water

| | | Trade | Coat weight |
|---|---|---|---|
| Example | Polymer type | designation | (g/m²) |
| | Terpolymers | | |
| 1 | VA/E/VC | CEF 19 | 1 |
| 2 | VC/E/VE | CEF 52 | 4 |
| 3 | VA/E/VC | CEF 19 | 4 |
| 4 | VC/VA/E | CEF 35 | 4 |
| 5 | VC/E/VE | CEF 52 | 1 |
| | Copolymers | | |
| 6 | VC/E | CEN 752 | 4 |
| 7 | VC/VA | CF 70 | 4 |
| 8 | VC/E | CEN 752 | 1 |
| 9 | VA/E | EPN 865 | 1 |
| 10 | VC//VA | CF 70 | 1 |
| Functionalised vinylidene halide | | | |
| 11 | PVdC copolymer | A 115 | 2 |

In the above table: PVdC denotes poly vinylidene chloride polymer; E denotes an ethylene monomer; VC denotes a vinyl chloride monomer; VA denotes a vinyl acetate monomer and VE denotes a vinyl ester monomer.

The following reference films were also printed and tested as described herein. The comparative coated films were primed with mica prior to top coating except Comp C which did not use any primer.

Comp A was an conventional uncoated PVC film.

Comp B was conventional uncoated BOPP film.

Comp C was a conventional BOPP film coated with 1 g/m² of a conventional aqueous ethylene/acrylic acid (E/M) copolymer coating formulation (15% by dry solids) also containing wax and PMMA anti-block. The E/AA used comprised 20% acrylic acid and was dispersed in an excess of ammonia and water to neutralise and solubilise the polymer. Comp D was a conventional BOPP film coated with 1 g/m² of a conventional aqueous acrylic acid coating formulation (15% by dry solids). This coated film was available commercially from UCB Films under the trade designation WGS.

Comp E was a conventional BOPP film coated with 2 g/m² of a conventional non functionalised PVdC coating formulation (45% by dry solids) available commercially from Solvin under the trade designation Ixan A-36.

The percentage base width data for the Examples 1 to 11 and prior art Comp A to E are given in the Figures herein where FIG. 1 presents the terpolymer coating data, FIG. 2 the copolymer coating data and FIG. 3 the PVdC coating data.

In the Figures Examples 1 to 11 show lower flatter trend lines compared to Comp A to E. The ink jet droplets of a conventional black solvent ink printed onto the surface of the coated films of the present invention generally reach their maximum width within a much shorter timeframe that for the prior art substrates which gives improved print resolution at higher print speeds. The spread of the ink droplet is very slight on the surface of the films of the invention.

As can be seen the prior art films are less suitable for printing by an inkjet ink. FIG. 1, FIG. 3 and FIG. 4 show Comp A (PVC) and B (uncoated BOPP) are less printable with ink-jet inks as they exhibit a much greater degree of dot spread than respectively the terpolymer coated Examples 1 to 5; the copolymer coated Examples 6 to 10 or the functionalised PVdC coat of Example 11. Coatings of the present invention are thus surprisingly advantageous even over PVC which was believed to be ink-jet printable.

FIG. 3 also shows that copolymers of the invention Examples 6 to 10 are unexpectedly better ink receptive coatings than similar E/M copolymers of Comp C. FIG. 4 shows that the functionalised acrylic/PVdC copolymer of Example 11 is a surprisingly more ink-jet printable surface than either acrylic (Comp D) or non functionalised PVdC (Comp E) on their own.

1. An ink jet printable polymer film optionally selected from polyolefin, polyester, polyamide, acrylic, polystyrene, or polyurethane, where the film is coated with an ink jet printable ink receiving layer which when ink jet printed has an average percent increase in droplet size on the ink receiving layer of no more than about 5% measured between about 0.2 and about 2.0 sec after printing.

2. A polymer film as claimed in claim 1, where the average percent increase in droplet size on the ink receiving layer is no more than about 2% measured between about 0.2 and about 2.0 sec after printing.

3. An ink jet printable polymer film optionally selected from polyolefin, polyester, polyamide, acrylic, polystyrene, or polyurethane, where the film is coated with an ink jet printable ink receiving layer which comprises at least one halogenated terpolymer obtained and/or obtainable from three polymer precursors each separately comprising the following functional groups:
(a) halogenated hydrocarbylidene.
(b) hydrocarbylidene substituted by at least one ester group; and
(c) unsubstituted hydrocarbylidene.

4. A polymer film as claimed in claim 1, where the ink-jet printable layer comprises at least one halogenated terpolymer obtained and/or obtainable from three polymer precursors each separately comprising the following functional groups:
(a) halogenated hydrocarbylidene.
(b) hydrocarbylidene substituted by at least one ester group; and
(c) unsubstituted hydrocarbylidene.

5. A polymer film as claimed in claim 3, where the terpolymer is obtained and/or obtainable from the following three monomers
(a) halogenated vinyl, optionally vinyl chloride.
(b) vinyl ester, optionally vinyl acetate; and
(c) olefin, optionally ethylene.

6. An ink jet printable polymer film optionally selected from polyolefin, polyester, polyamide, acrylic, polystyrene, or polyurethane, where the film is coated with an ink jet printable ink receiving layer which comprises at least one copolymer obtained and/or obtainable from two of the following polymer precursors each separately comprising the following functional groups:
(i) halogenated hydrocarbylidene.
(ii) hydrocarbylidene substituted by at least one ester group; and
(iii) unsubstituted hydrocarbylidene.

7. A polymer film as claimed in claim 1, where the ink jet printable layer comprises at least one copolymer obtained and/or obtainable from two of the following polymer precursors each separately comprising the following functional groups:
(i) halogenated hydrocarbylidene.
(ii) hydrocarbylidene substituted by at least one ester group; and
(iii) unsubstituted hydrocarbylidene.

8. A polymer film as claimed in claim 6, where the copolymer is obtained and/or obtainable from two out of the following three monomers
(i) halogenated vinyl, optionally vinyl chloride;
(ii) vinyl ester, optionally vinyl acetate; and/or
(iii) olefin, optionally ethylene.

9. An ink jet printable polymer film optionally selected from polyolefin, polyester, polyamide, acrylic, polystyrene, or polyurethane, where the film is coated with an ink jet printable ink receiving layer which comprises at least one a vinylidene halide copolymer obtained and/or obtained from
(x) a PVdX polymer precursor; and
(y) at least one functionalised acrylic polymer precursor which comprises an olefinic monomer substituted by one or more non-halogenated electronegative groups (optionally organo groups).

10. A polymer film as claimed in claim 1, where the ink jet printable layer comprises at least one a vinylidene halide copolymer obtained and/or obtained from
(x) a PVdX polymer precursor; and
(y) at least one functionalised acrylic polymer precursor which comprises an olefinic monomer substituted by one or more non-halogenated electronegative groups (optionally organo groups).

11. A polymer film as claimed in claim 9, where the functionalised acrylic polymer precursor(s) (y) are substituted by at least one hydroxy, carboxy, cyano and/or amide groups.

12. A polymer film as claimed in claim 11, where the functionalised acrylic polymer precursor(s) (y) are substituted by at least one C1_{—}6hydrocarbo (optionally CM-0, alkyl) and/or C1_shydrocarboxy (optionally C1.4alkoxy) group.

13. A polymer film as claimed in claim 12, where the polymer precursor(s) (y) are selected from hydroxy(meth)acrylic, (meth)acrylic acid, (meth)acyrlonitile and/or (meth)acrylamide.

14. A polymer film as claimed in claim 9, where the amount of polymer precursor (y) comprises from about 0.1% to about 49% by total dry weight of the polymer.

15. A polymer film as claimed in claim 14, where the polymer precursor (y) comprises from about 3% to about 15% by total dry weight of the vinylidine halide copolymer

16. A method of printing a film as claimed in claim 1—using an ink jet printer.

17. A printed film obtained and/or obtainable by a method as claimed in claim 16.

18. A label facestock and/or graphic arts display comprising a film as claimed in claim 1.

19. (canceled)

20. A method of printing a film as claimed in claim 3 using an ink jet printer.

21. A method of printing a film as claimed in claim 6 using an ink jet printer.

22. A method of printing a film as claimed in claim 9 using an ink jet printer.

23. A printed film obtained and/or obtainable by a method as claimed in claim 20.

24. A printed film obtained and/or obtainable by a method as claimed in claim 21.

25. A printed film obtained and/or obtainable by a method as claimed in claim 22.

26. A label facestock and/or graphic arts display comprising a film as claimed in claim 3.

27. A label facestock and/or graphic arts display comprising a film as claimed in claim 6.

28. A label facestock and/or graphic arts display comprising a film as claimed in claim 9.
